(19) United States
(12) Patent Application Publication
(10) Pub. No.: US 2007/0131754 A1
(43) Pub. Date: Jun. 14, 2007

(54) Method and system of collecting data using unmanned vehicles having releasable data storage devices

(76) Inventor: Frank L. Brandon, Sulphur Springs, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/301,193

(22) Filed: Dec. 12, 2005

(51) Int. Cl. G06F 17/00; G07B 15/02

(52) U.S. Cl. 235/375; 235/384

(57) ABSTRACT

Methods and systems are disclosed for gathering data with unmanned vehicles (UMVs) in a specific area, storing gathered data on one or more RFID devices or some other data storage devices, and releasing these devices holding stored data for subsequent detection and analysis of the stored data by another system. In one embodiment, an RFID-enabled UMV system of the present invention is configured to collect data using a plurality of RFID tags and to release the RFID tags with the stored data in selected locations. An RFID tag analysis system is configured to obtain and analyze the data stored in the released RFID devices. Analysis of the stored data can be performed in a variety of ways, including manual analysis, analysis by an RFID reader, computer processing of the data, or any other desired analysis of the data. Alternative data storage devices include non-volatile memory devices that can store data, be released by the UMV, and be later processed by other systems.

### TECHNICAL FIELD OF THE INVENTION

This invention relates to the use of unmanned vehicles (UMVs) to investigate dangerous or hostile environments and, more particularly, to acquisition of data in such environments. Background

A wide variety of RFID (radio frequency identification) systems are currently available, and uses for RFID devices cover a wide range of applications. These applications are primarily directed to the storage of information relating to a person or object with respect to which the RFID device is associated. For example, the data stored on the RFID devices can be read by an RFID reader device and analyzed in order to identify people or objects. As such, RFID device technology has been used for such tasks as tracking livestock and pets, triggering equipment in oil wells, tracking goods in a supply chain, and for security and payment systems. In such applications, RFID systems can be used to increase efficiency and reduce data entry errors.

Typical RFID devices are constructed to store desired information within an integrated circuit (IC) within the RFID device, and this IC is attached to antenna circuitry for external communications. The IC and antenna combined typically makeup an RFID device or tag. RFID tags can be active or passive. The IC also typically includes data storage circuitry such as read only memory (ROM) or non-volatile programmable memory circuitry, such as FLASH memory, electrically programmable memory, or one time programmable memory. Active RFID tags have a battery that can be used to run the internal circuitry and to power the antenna in order to broadcast a signal to an RFID reader. Passive tags have no battery, and instead, draw power from the electromagnetic waves sent by the reader that induce a current in the tag's antenna. While the read-range (i.e., range at which the reader must be placed from the RFID tag in order to read the tag) for passive RFID tags is not as far as for active RFID tags, passive RFID tags are more commonly used because they are much less expensive than active tags.

In operation, an RFID tag sends and receives information to and from the RFID reader through its antenna. Typically, to initiate the process, the reader sends out RF signals that act to energize passive tags and to wake-up active tags. The tag antenna is typically tuned to receive RF signals at particular frequencies at which the reader is transmitting. The tags then send RF signals back to the reader. The reader then receives these signals and converts them into digital data. The reader can then analyze this data and/or transmit the digital data to other computer or processing systems for analysis. It is also noted that various modulation and coding techniques can be used for RFID tags and readers in order to ensure data integrity and security.

Unmanned vehicles (UMVs) have been developed for use in a variety of applications, including domestic and military applications where environments are hostile or dangerous to persons. Typical UMVs are robotic vehicles that are either pre-programmed to traverse a particular course or can be manipulated electronically by a user from a distance. The growing utilization of unmanned autonomous vehicles creates special problems in communications between humans and these vehicles as well as between the vehicles themselves. Current art approaches often use some form of direct RF communications links. However, there are some applications where conventional RF communications links are not feasible or practical, such as with military applications where covertness along with autonomous operations by both humans and unmanned vehicles is a requirement. Existing approaches do not adequately handle these circumstances.

### SUMMARY OF THE INVENTION

The present invention provides a method and system for gathering data with unmanned vehicles (UMVs) in a specific area, storing gathered data on one or more RFID devices or some other data storage devices, and releasing these devices holding stored data for subsequent detection and analysis of the stored data by another system. In one embodiment, an RFID-enabled UMV system of the present invention is configured to collect data using a plurality of RFID tags and to release the RFID tags with the stored data in a selected location. An RFID tag analysis system is configured to obtain the stored data from the released RFID devices and then to analyze the data. Analysis of the stored data can be performed in a variety of ways, including manual analysis, analysis by an RFID reader, computer processing of the data, or any other desired analysis of the data. The RFID tags of the present invention are preferably passive tags that are energized by an interrogating signal from the reader. Examples of applications into which the RFID-enabled UMVs can be deployed include chemical testing, radiation testing, identification of people (e.g., in a hostile environment), audio data collection, video data collection, and/or any other desired application. Alternative data storage devices include non-volatile memory devices that can store data, be released by the UMV, and be later processed by other systems. As described below, other features and variations can be implemented, if desired, and a related method can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram of an example embodiment for an unmanned vehicle (UMV) including releasable RFID tags according to the present invention.

FIG. 2 is a block diagram of an example embodiment for a target area environment showing multiple UMVs releasing RFID tags with stored information according to the present invention.

FIG. 3 is a block diagram of an example embodiment for a tag identification and analysis system according to the present invention.

FIG. 4 is a flowchart describing an example process for the collection, storing, and analysis of data using releasable RFID devices and UMVs according to the present invention.

### DETAILED DESCRIPTION OF THE INVENTION

The present invention relates to gathering data with unmanned vehicles (UMV) and storing this data on releasable data storage devices, such as RFID tags, so that these devices may be released by the UMVs in a selected area for subsequent detection of the devices and analysis of the data stored on the devices. UMVs with releasable data storage devices (e.g., RFID tags) according to the present invention can be used in any of a wide variety of applications where UMVs are desired to be used to collect and gather data for analysis.

In part, the present invention provides a method and system for gathering data with UMVs from a specific area, storing gathered data on data storage devices, and releasing storage devices holding stored data for subsequent detection and analysis of said data. In one embodiment, the data storage devices are RFID devices. In this embodiment, the RFID-enabled UMVs of the present invention are then configured to collect data using a plurality of RFID tags housed in the UMVs, and the UMvs are also configured to release the RFID tags with the stored data in selected locations. An RFID tag analysis system is configured to obtain the stored data from the dropped RFID tags and then to analyze the data. Analysis of the stored data can be performed in a variety of ways, including manual analysis, analysis by an RFID reader, computer processing of the data, or any other desired analysis of the data. The RFID tags of the present invention are preferably passive tags that are energized by an interrogating signal from the reader. Examples of applications into which the RFID-enabled UMVs can be deployed include chemical testing, radiation testing, identification of people (e.g., in a hostile environment), audio data collection, video data collection, and/or any other desired application.

The method and system of the present invention of collecting and storing data using UMvs and releasable and locatable data storage devices (e.g., RFID tags) allows for improved communications between UMVs and humans. This method of communication among UMVs or robotic vehicles and another UMV or a human is relatively covert and, therefore, would not disclose the location of any of the friendly forces in a military situation. The present invention is especially useful with UMVs that are too small to carry a conventional communications system. While UMVs can be pre-programmed for data collection in a particular area, because the invention allows for communication between multiple UMVs, the UMVs can independently alter their pre-programmed course based on information received from other UMVs, specifically information regarding danger to a UMV in an area. In addition, to facilitate covert applications, the data storage devices of the present invention, if desired, can be disguised or configured so that they would be undetected by a casual observer/human. One approach for achieving this result would be is to use data storage devices that are very small or data storage devices that are camouflaged to look like environment in which they are dropped from the UMVs.

In one application, a team of UMVs of the present invention each work autonomously but also has a need to communicate information to other UMVs or humans. One mission may require searching an area forward of troop movement to identify enemy activity or to locate mines or other such anti-personnel weapons. The UMVs of the present invention can be pre-programmed with a particular search area or target area. When obstacles or other encumbrances are encountered by the UMVs requiring alteration of the pre-programmed area, the UMVs can be configured such that a first UMV will release an RFID device or other data storage device with relevant data and instructions so that other UMVs following the same or general path in the target area can identify the release RFID tag, read the data stored on it, and take action based upon that data. Also, as one UMV detects a mine or other threat, the location of this threat could be communicated to other devices or systems through information stored on an RFFD device dropped at or near the location of the threat.

The released or dropped RFFD device can be identified through the use of an RFID reader. As discussed herein, for passive RFID devices, an RFID reader transmits an interrogating signal that energizes the RFID device so that the RFID device can communicate back to the reader. For active RFID devices, the RFID device can transmit a beacon signal that will allow the RFID reader or other device to locate its presence. If desired, an active RFID device could also be configured to wake-up at a particular time after deployment or release from the UMV for transmission of such a beacon, for example, where the hostile nature of the environment is time sensitive. It is further noted that, if desired, other type of markers or marking systems could be utilized to identify the location of a released or dropped RFID device. For example, UMVs could be equipped with special chemical markers (e.g., paints, compounds, etc.) that can be placed or sprayed near the released RFID device so that a subsequent UMV, person or person-controlled vehicle or device could identify the chemical marker and then know to look for and find the released RFID device. Still further, the RFID devices themselves could be made using particular materials to that they can be easily identified. These materials could be, for example, materials that produce an identifiable signature, such as a radioactive signature or other chemical signature. In short, a wide variety of mechanisms could be employed in order to allow the RFID devices to be identified once deployed or released from the UMVs.

It is further noted if the device marker allows for the RFID devices to be identified without receiving a signal from the RFID devices, the devices could be configured without the antenna and RF communication circuitry. In such a case, the device would become a releasable non-volatile (NV) data storage device rather than a passive or active RFID device that respond to REID readers. The UMVs would store data on such releasable NV data storage devices and then deploy or release them at selected locations for later data collection operations. In addition, where pre-determined release locations are utilized, as discussed below, such releasable NV data storage devices would potentially facilitate covert operations. Thus, in additional to releasable RFID devices, the present invention also contemplates the use of any releasable and locatable data storage device that can store data, can be released by the UMV, can be located by other UMVs or systems or persons, and can be processed to extract the stored data for analysis and use.

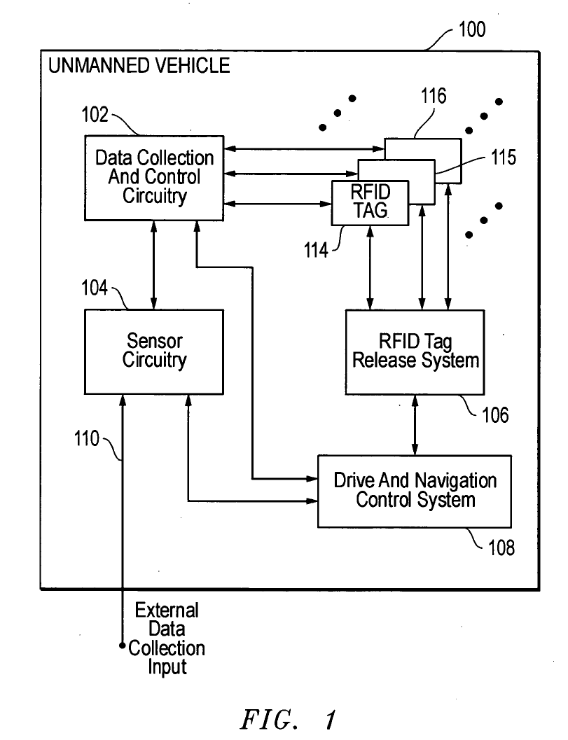

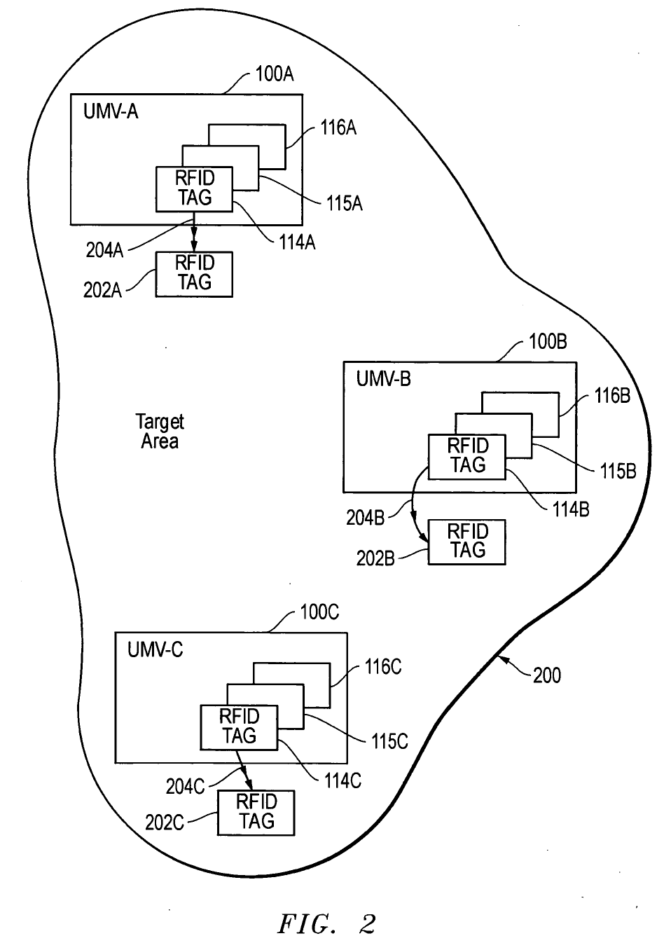

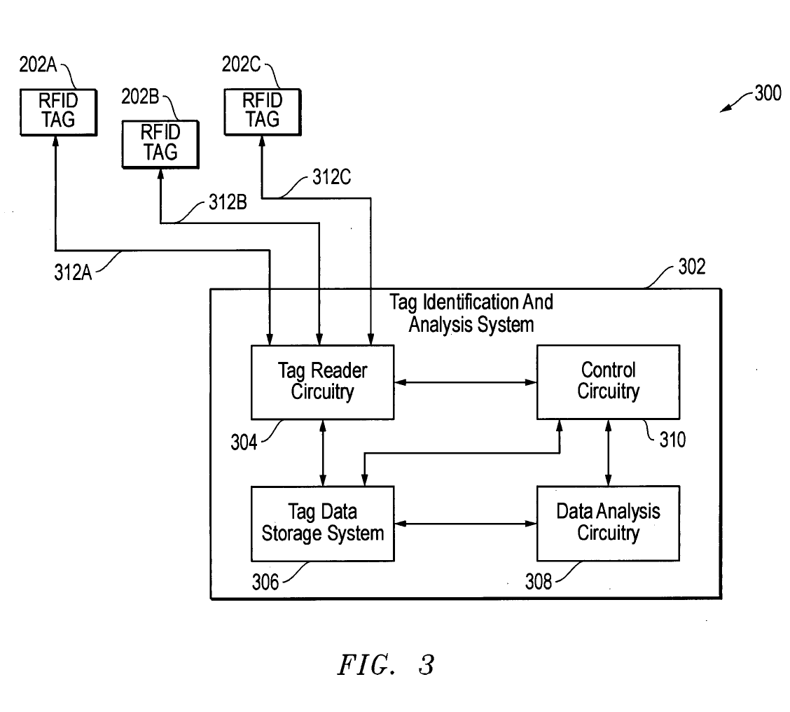

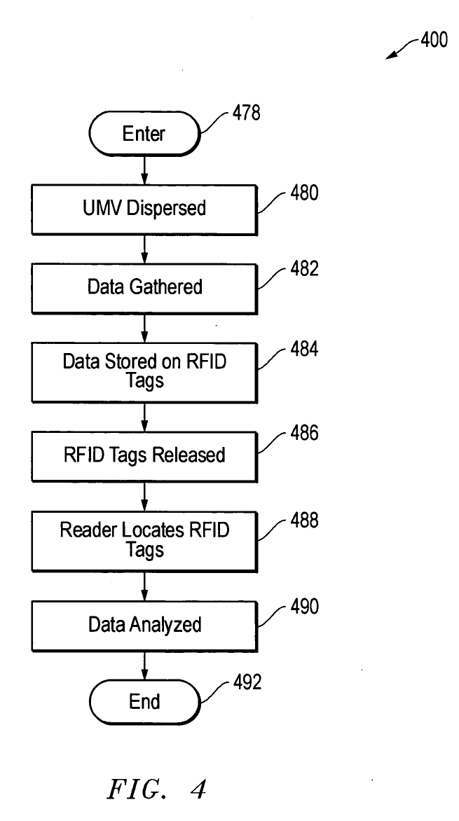

Example embodiments for the present invention will now be described with respect to the drawings. In these embodiments, the data storage devices are assumed to be RFID devices or tags. FIG. 1 is an example block diagram for an unmanned vehicle (UMV) including releasable RFID tags. FIG. 2 is an example block diagram for a target area environment showing multiple UMVs releasing RFID tags with stored information. FIG. 3 is an example block diagram for a tag identification and analysis system. And FIG. 4 is a flowchart describing an example process for the collection, storing, and analysis of data using releasable RFID devices and UMVs.

Looking now to FIG. 1, an example embodiment for an unmanned vehicle (UMV) 100 is depicted. A plurality of RFID tags 114, 115, 116 . . . are attached, held our housed by the UMV 100 and are configured to store data collected by the UMV 100. This data can be obtained, for example, from external data collection input 110 to sensor circuitry 104 associated with the UMV 100. The sensor circuitry 104 can then send data to the data collection and control circuitry 102. The data collection and control circuitry can be programmed to control the collection of data through the sensing circuitry 104 and to store data on the RFID tags 114, 115, 116 . . . depending upon the application into which the UMVs 100 are deployed. As depicted, the UMV 100 also includes RFID tag release system 106 that is configured to deploy or release the RFID tags 114, 115, 116 . . . at selected locations once they contain data that is desired to be communicated to other UMVs, to other systems, or to persons. A drive and navigation control system 108 is also provided to control the movement of the UMV 100. In addition, the drive and navigation control system can be coupled to sensor circuitry 104, the data collection and control circuitry 102, and the RFID tag release system in order to provide data inputs for determining location information for the UMV 100. It is noted that movement of the UMV in a target area can be pre-programmed for a specific course or controlled electronically by an external user from a distance, as desired. If the UMV 100 is to be externally controlled, then a communication and control mechanism will be included within the UMV 100 so that external control can be implemented.

In operation, when a UMV 100 is sent to a target area for data collection, data collection and control circuitry 102 receives data from the external data collection input 110 through sensor circuitry 104. The collected data is processed and stored on one or more of the plurality of RFID tags 114, 115, 116 . . . housed within UMV 100. The RFID tag release system 106 is then used to release the RFID tags at selected locations. Released RFID tags with stored information are subsequently detected by a reader and can be analyzed manually, by a reader, by a computer, or by any other desired system.

The drive and navigation control system 108 of FIG. 1 can be configured for intelligent course control, if desired. For example, the drive and navigation control system 108 can alter a pre-programmed course based on information received via external data collection input 110 and sensor circuitry 104. In addition, the UMV 100 can be configured to use sensor circuitry 104 to read RFID tags left by another UMV in a same target area. When obstacles or other encumbrances are encountered by the UMVs requiring alteration of the programmed paths for the UMVS, the RFID tags provide a method by which a first UMV can communicate to other UMVs following the same general path in the same target area. Also, as one UMV detects a mine or other threat, the location of the threat can be communicated through the RFID tags to other UMVs and/or humans.

The UMV 100 shown in FIG. 1 can be implemented using a wide variety of structures. For example, the UMVs could be mobile, electromechanical devices that have intelligent programming to control movement and actions. Mobility can be provided, for example, using wheels, robotic legs, fans, wings, or any other desired mechanical system for providing independent movement of the UMV 100. The UMV 100 could also be configured to travel through any desired medium or combinations of mediums, including as land-based travel, water-based travel and air-based travel.

As indicated above, RFID devices can be active or passive devices and can be implemented in a variety of ways. RFID devices typically include an antenna coupled to an integrated circuit (IC). The IC also typically includes non-volatile data storage circuitry such as read only memory (ROM) or non-volatile programmable memory circuitry, such as FLASH memory, electrically programmable memory, or one time programmable memory. Active RFID devices include batteries or power sources that provide power needed by the RFID device circuitry to operate. Passive RFID devices are energized by the interrogating field from the RFID reader in. order to generate the power needed by the RFID device circuitry to operate. Depending upon the application for the UMVs of the present invention, different RFID devices may be advantageous. In addition, as indicated above, other types of data storage devices could also be used as long as mechanisms were in place to be able to locate those data storage devices. On such alternative device could be, for example, a programmable non-volatile (NV) memory device to which data could be written by the UMV. The NV device could then be released or deployed by the UMV. Either by a marker or by geo-location, the NV device could be located and processed to obtain the stored data. In short, alternative types of storage devices could be utilized while still taking advantage of the UMVs with releasable data storage devices according to the present invention.

FIG. 2 is a block diagram showing a target area environment 200 with multiple UMVs 100A, 100B, 100C . . . , each having a set of one or more RFID tags. As depicted, a first UMV (UMV-A) 100A includes RFID tags 114A, 115A and 116A. A second UMV (UNMV-B) 100B includes RFID tags 114B, 115B and 116B. And a third UMV (UMV-C) 100C includes RFID tags 114C, 115C and 116C. FIG. 2 also shows the releasing of RFID tags with stored information. In particular, UMV 1OOA has released RFID tag 202A as represented by line 204A. UMV 100B has released RFID tag 202B as represented by line 204B. And UMV 100C has release RFID tag 202C as represented by line 204C. The RFID tags 202A, 202B and 202C are released through the respective RFID tag release systems of each of the UMVs. As indicated above, the RFID tags 202A, 202B and 202C are released once data has been collected and stored, and the control circuitry within the UMV has decided to release the RFID tag with stored information.

Example applications for which data can be stored on RFID tags includes chemical testing, radiation testing, people identification (e.g., in hostile environments), audio data collection, video data collection, mine detection and any other desired activity. As indicated above, the RFID tags of the present invention can be disguised, if desired, so they would be difficult to detect by a casual observer/human. In addition, multiple UMVs can communicate information between each other in a same target area through the use of released RFID tags. This information can include items such as information regarding dangerous or treacherous terrain, landmines, predators, and/or any other desired information. Based upon this information, a UMV can alter its course, actions or mission.

FIG. 3 is a block diagram of an environment 300 in which tag identification and analysis system 302 is identifying and collecting information from released RFID devices. As depicted, the tag identification and analysis system 302 includes tag reader circuitry 304, tag data storage system 306, control circuitry 310 and data analysis circuitry 308. Where the released RFID devices or tags 202A, 202B and 202C are passive tags, the reader circuitry 304 can be configured to transmit an interrogating signal in order to initiate communications. The released RFID devices or tags 202A, 202B and 202C can then become energized and respond with appropriate communication signals in order to transfer the stored data to the tag identification and analysis system 302. The data stored in the released RFID devices or tags 202A, 202B and 202C can then be stored in the tag data storage system 306 and analyzed by the data analysis circuitry 308.

In operation, RFID devices 202A, 202B and 202C are energized by the interrogating signal represented by communication lines 312A, 312B and 312C in FIG. 3. Released RFID tags 202A, 202B, 202C in a target area 300 receive the interrogatory signals 312A, 312B and 312C, are energized, and then communicate data back to the tag identification and analysis system 302 through communication lines 312A, 312B, 312C. The data obtained from the tags 202A, 202B and 202C can then be sent to be stored in tag data storage system 306 for later processing by the data analysis circuitry 308.

As indicated above, the released RFID tags 202A, 202B and 202C can be located in a number of different ways, i.e. by a human manually, by a human with a reader or analysis system 302, by a UMV with an analysis system 302, or in any other desired manner. Once located, the data stored on the RFID tag can be read and downloaded with the tag identification and analysis system 302. If desired, one or more different systems can perform the analysis of the stored data obtained from released tags 202A, 202B and 202C, or the analysis can be done by the same system, i.e., the tag identification and analysis system 302, as desired. Alternatively, the data analysis could be performed manually. It is further noted that other techniques for acquiring and analyzing the data stored in the RFID tags could be utilized if desired while still utilizing UMVs with releasable RFID tags according to the present invention.

It is further noted that the locations at which the RFID tags 202A, 202B and 202C are released can be determined based upon any of a variety of factors. The drop locations could be pre-determined so that the UMV collects data and drops an RFID device at a particular location. In this way, other UMVs, systems or persons could locate the released RFID device based upon the coordinates selected for the drop. If desired, global positioning system (GPS) receivers could be used for geo-location in order to increase the precision of RFID device release points. Drop locations could also be determined by pre-programmed algorithms stored within the UMV such that the RFID tags are released when they have stored as much data as they can, at specific points of time, when particular events occur, when particular objects are identified, and/or any other desired factor. In short, the release criteria can be configured to provide for desired operation depending upon the application for which, and environment into which, the UMVs with releasable RFID tags according to the present invention are deployed.

FIG. 4 is a flowchart describing an example embodiment 400 for steps involved in the present invention. First, the process begins in process step 478. Next, in process step 480, UMVs with releasable RFID devices are dispersed in a target area. As indicated above, these UMVs can be controlled using a variety of techniques, including being pre-programmed with regard to the area to be searched and the types of data targeted for collection. The UMVs could also be controlled electronically by an external user from a distance though a communication interface, if desired. Further, these UMVs can detect and transmit information regarding terrain, dangerous conditions, and other pertinent information for transfer to the other UMVs in the same target area through released RFID devices. UMVs obtaining information from released RFID devices can use this information to adjust their operations. For example, where undesirable areas are identified, the UMV can adjust its course to avoid these undesirable areas.

In step 482, the UMVs act to gather data. In step 484, the data is stored by the UMV on one or more RFID tags that are housed within or associated with the UMVs. In step 486, the RFID tags are then released by the RFID tag release system within the UMV. As indicated above, the tag release system can be programmed to release a tag in a certain area where the tag's data was collected, to release all tags in one specific area within the target area after all data is collected, or to release the RFID tags according to any other desired algorithm depending upon the application into which the UMVs were deployed. Subsequently, in step 488, the RFID tags are located, for example, by use of an RFID tag reader. The stored data from the RFID tags is then analyzed in step 490, either manually, by the reader, by a computer, or through any other desired process. The process embodiment 400 then ends in step 492.

The applications for the RFID-enabled UMVs of the present invention are widely varying and include commercial and military objectives. For example, in certain military operations, an area forward of troop movement can be searched to identify enemy activity, to locate mines or other such anti-personnel weapons, or to achieve some other desired objective. Troops can gather information covertly prior to reaching the searched area using an undetected UMV with RFID tags of the present invention. The gathered information stored on RFID tags can be analyzed covertly without giving away the location of the troops. When information is analyzed, decisions can be made regarding the mission, navigation, and/or other objectives. Subsequent friendly troops traversing the same route are able to benefit from information stored on the RFID tags by detecting the RFID tags and accessing the stored information. To facilitate security of the data stored on the RFID tags, security measures can be taken such as encrypting the data, requiring codes in order to send appropriate communication signals, hiding the RFID tags, making the RFID tags difficult to locate, or any other desired security measure. In this way, enemy troops would have difficulty detecting the RFID tags and accessing the stored information.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein and certain features of the invention may be utilized independently of the use of other features, all as would be apparent to one skilled in the art after having the benefit of this description of the invention.

What is claimed is:

1. An unmanned vehicle configured to collect data, comprising:
one or more releasable data storage devices coupled to the unmanned vehicle, each releasable storage device being configured to store data collected by the unmanned vehicle; and
a release system configured to release the releasable data storage devices from the unmanned vehicle.

2. The unmanned vehicle of claim 1, wherein the data storage devices comprise programmable non-volatile memory devices.

3. The unmanned vehicle of claim 1, wherein the data storage devices comprise radio frequency identification (RFID) devices.

4. The unmanned vehicle of claim 3, wherein each RFID device comprising antenna circuitry coupled to an integrated circuit.

5. The unmanned vehicle of claim 3, further comprising sensor circuitry configured to collect environmental data through an external data collection input, and further comprising data collection and control circuitry configured to receive data from the sensor circuitry and to store data on the releasable RFID devices.

6. The unmanned vehicle of claim 5, further comprising drive and navigation control system configured to control positioning of the unmanned vehicle and configured to provide control data to the data collection and control circuitry and to the release system.

7. The unmanned vehicle of claim 6, further comprising wheels or robotic legs that are configured to provide mobility for the unmanned vehicle.

8. A system for obtaining data from a target environment, comprising:
a plurality of unmanned vehicles each being configured to collect data, each unmanned vehicle comprising:
one or more releasable data storage devices coupled to the unmanned vehicle, each releasable storage device being configured to store data collected by the unmanned vehicle; and
a release system configured to release the releasable data storage devices from the unmanned vehicle; and
an reader system configured to obtain data from the storage devices and to process the data.

9. The system of claim 8, wherein the data storage devices comprise radio frequency identification (RFID) devices.

10. The system of claim 9, wherein the RFID devices comprise passive RFID devices that are energized by an interrogating signal.

11. The system of claim 9, wherein the reader system comprises a single reader system.

12. The system of claim 9, wherein the unmanned vehicles each include a reader system.

13. The system of claim 8, wherein each unmanned vehicle comprises global positioning system (GPS) receiver circuitry and wherein data from the GPS receiver circuitry is utilized to determine a location at which to drop one or more data storage devices.

14. The system of claim 9, wherein the reader system is further configured to identify a location for at least one released RFID device.

15. The system of claim 8, wherein the unmanned vehicles are configured to have a programmed course and are configured to alter the programmed course based on information received from other unmanned vehicles in a target area through released data storage devices.

16. A method for obtaining data from a target environment, comprising:
deploying at least one unmanned vehicle having one or more releasable data storage devices;
gathering data from said target environment with the unmanned vehicle;
storing the data on at least one of the releasable data storage devices;
releasing from the unmanned vehicle one or more releasable data storage devices having stored data;
obtaining data from the released data storage device; and
analyzing the data.

17. The method of claim 16, further comprising identifying a location for at least one released data storage device.

18. The method of claim 17, wherein the data storage devices comprise radio frequency identification (RFID) devices.

19. The method of claim 18, further comprising energizing the passive RFID devices with an interrogating signal to obtain data from the passive RFHD devices.

20. The method of claim 16, further comprising obtaining data from the released data storage devices using one or more additional unmanned vehicles.

21. The method of claim 16, wherein the deploying step comprises deploying a plurality of unmanned vehicles having one or more releasable data storage devices and wherein a plurality of releasable data storage devices are released from the unmanned vehicles.
